(19) United States
(12) Patent Application Publication
(10) Pub. No.: US 2025/0303669 A1
(43) Pub. Date: Oct. 2, 2025

(54) DUCT WRAP INSULATION

(71) Applicant: Owens Corning Intellectual Capital, LLC, Toledo, OH (US)

(72) Inventor: James W. Rinne, Westerville, OH (US)

(21) Appl. No.: 19/235,906

(22) Filed: Jun. 12, 2025

Related U.S. Application Data
(63) Continuation of application No. 17/986,952, filed on Nov. 15, 2022.
(60) Provisional application No. 63/279,627, filed on Nov. 15, 2021.

(51) Int. Cl. B32B 5/26; B32B 5/02; B32B 7/022; B32B 29/02

(52) U.S. Cl. CPC B32B 5/266; B32B 5/022; B32B 29/02; B32B 7/022; B32B 2250/02; B32B 2250/03; B32B 2255/02; B32B 2262/02; B32B 2262/101; B32B 2307/304; B32B 2307/554; B32B 2307/582; B32B 2307/718; B32B 2307/732

(57) ABSTRACT

An insulation product includes a first layer of a fibrous insulating material, a second layer of a facing material attached to a first surface of the first layer, and a third layer of a slip sheet material and/or a lubricant attached to a second surface of the first layer. The first surface and the second surface are on opposite sides of the first layer and are parallel to one another. For certain applications, the insulation product may include a layer of a slip sheet material and/or lubricant attached to the first surface of the first layer instead of the second layer of a facing material.

### CROSS-REFERENCE TO RELATED APPLICATIONS

This application is a continuation of U.S. Non-Provisional patent application Ser. No. 17/986,952, filed Nov. 15, 2022, which claims priority to and the benefit of U.S. Provisional Patent Application No. 63/279,627, filed Nov. 15, 2021, the entire disclosures of which are incorporated herein by reference in full.

### TECHNICAL FIELD

The present disclosure relates generally to insulation products and, more specifically, to a duct wrap with improved durability, maneuverability, and resistance to, for example, fiber transfers, fiber shedding (e.g., caused by peel-backs, insulation bunching, and the like), punctures, and/or wrinkles.

### BACKGROUND

Systems for heating and/or cooling air typically include ducts for distributing the heated or cooled air where needed, for example, the rooms of a commercial or residential building.

Air ducts are often made of sheet metal and provide little (limited) insulative value. As a result of this limited insulative value, excessive heat is transferred into or out of the ducts (e.g., from or into unconditioned spaces), significantly increasing heating and cooling bills.

Heat transfer may be generally reduced by insulating and sealing the air ducts, for example, with a duct wrap insulation. Duct wrap insulation prevents heat transfer between the air flowing through the air ducts and the ambient air surrounding the air ducts. As shown in FIG. 1, traditional duct wrap insulation 10 includes an insulating layer 20 (e.g., a fiberglass layer) covered on one side by a Foil Scrim Kraft (FSK) facing 30 (also referred to as a “facer”). The side of the fiberglass layer 20 opposite the facer 30 is exposed in the traditional duct wrap insulation 10.

The areas around the air ducts, where the duct wrap insulation 10 is installed, may be narrow and tightly spaced due to the close proximity of other building components (e.g., drywall and structural supports). Installing the duct wrap insulation 10 in narrow, tightly spaced areas requires the insulation to be threaded through gaps/openings that are narrower than the duct wrap's thickness, often resulting in the exposed fiberglass layer 20 shedding and/or peeling-back from (or bunching up under) the facer 30. Peel-backs (or insulation bunching) are undesirable, as they slow the insulation process and can compromise the overall effectiveness of the duct wrap insulation 10. Consequently, such peel-backs (or insulation bunching) often cause installers to do a substantial amount of rework to properly insulate the ducts.

Another issue with traditional duct wrap insulation 10 is that the facer 30 is susceptible to punctures and tears when the duct wrap insulation 10 is being maneuvered about a construction site. Sharp objects at construction sites (e.g., fasteners, knives, edges of air ducts, etc.) tend to puncture and tear the facer 30 of the duct wrap insulation 10. These punctures/tears are quite common and can slow the insulation process, as installers must spend time repairing the duct wrap insulation 10 (e.g., with tape).

Also, when storing the traditional duct wrap insulation 10 in roll form, the fiberglass layer 20 may transfer its fibers and/or binder to an adjacent side (outermost surface) of the facer 30, especially in hot and humid conditions. This undesirable transfer of the bonded fiberglass to the facer 30 negatively impacts the aesthetics of the duct wrap insulation 10 when installed, causing installers to use valuable time wiping transferred fibers off the facer 30, or finding another insulation solution altogether.

In view of the above issues related to the handling and installing of traditional duct wrap insulation 10, there is an unmet need for an improved duct wrap insulation that is able to resist fiber transfer, fiber shedding, punctures, tears, and/or wrinkles, without comprising the flexibility and maneuverability of the duct wrap insulation.

### SUMMARY

In one exemplary embodiment, an insulation product includes a first layer of a fibrous insulating material, a second layer attached to a first surface of the first layer, and a third layer attached to a second surface of the first layer. The first surface and the second surface are on opposite sides of the first layer and are parallel to one another. In some embodiments, the fibrous insulating material includes glass fibers. The glass fibers may be continuous and/or chopped glass fibers. Additionally, or alternatively, the fibrous insulating material includes organic fibers. In some embodiments, fibers of the fibrous insulating material are bonded together using a binder. In other embodiments, the fibrous insulating material is binderless. In some embodiments, the second layer includes a FSK facing. In some embodiments, the third layer includes a veil. The veil may be a fiberglass veil. Additionally, or alternatively, the third layer may include a sheet material (e.g., a slip sheet or member) selected from one or more of a plastic film, a skin coat of binder, a wax paper, and a woven fabric. In some embodiments, a thickness of the first layer is equal to or greater than a combined thickness of the second layer and the third layer. In some embodiments, the third layer has a basis weight between 0.1 g/m² and 75.0 g/m². In some embodiments, the fiberglass veil has a basis weight between 0.56 g/m² and 20.0 g/m².

In another exemplary embodiment, an insulation product includes a first layer of a fibrous insulating material, and a second layer being formed from at least one of a slip sheet material and a lubricant. The second layer is attached to a first surface of the first layer. In some embodiments, the insulation product includes a third layer formed from at least one of a slip sheet material and a lubricant. The third layer is attached to a second surface of the first layer. The first surface and the second surface are on opposite sides of the first layer and are parallel to one another. In some embodiments, the second layer and the third layer are attached to their respective surfaces using an adhesive. In some embodiments, the second layer is a fiberglass veil and the third layer is at least one of a fiberglass veil and a silicone lubricating oil. In other embodiments, the second layer is a silicone lubricating oil and the third layer is at least one of a fiberglass veil and a silicone lubricating oil. In some embodiments, the second layer may be disposed between the first layer and the third layer. In other embodiments, the third layer may be disposed between the first layer and the second layer.

In yet a further exemplary embodiment, the insulation product has a coefficient of friction of 0.35 to 0.40. In some embodiments, the third layer (e.g., the fiberglass veil) of the insulation product has a coefficient of friction of 0.35 to 0.40. In some embodiments, the coefficient of friction of the fiberglass veil side of the insulation product is about 0.37. In other embodiments, the coefficient of friction is about 0.38.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the present disclosure will become better understood with regard to the following description and accompanying drawings in which:

FIG. 1 illustrates a conventional duct wrap insulation;

FIG. 2 illustrates an exemplary embodiment of an insulation product, in accordance with the general inventive concepts;

FIG. 3 illustrates a second exemplary embodiment of an insulation product, in accordance with the general inventive concepts;

FIG. 4 is a chart showing fiber shedding loss percentages (e.g., peel-back or bunching loss percentages) of various insulation products;

FIG. 5 illustrates a third exemplary embodiment of an insulation product, in accordance with the general inventive concepts;

FIG. 6 illustrates a fourth exemplary embodiment of an insulation product, in accordance with the general inventive concepts;

FIG. 7 illustrates a fifth exemplary embodiment of an insulation product, in accordance with the general inventive concepts;

FIG. 8 illustrates a sixth exemplary embodiment of an insulation product, in accordance with the general inventive concepts;

FIG. 9 is a graph showing coefficient of friction (COF) data for exemplary embodiments of the insulation product, in accordance with the general inventive concepts;

FIG. 10 is a graph showing COF data of various insulation products;

FIG. 11 is a graph showing dust generation data for exemplary embodiments of the insulation product, in accordance with the general inventive concepts;

FIG. 12 is a graph showing dust generation data of various insulation products; and

FIG. 13 is a graph showing fiber transfer to facer data of various insulation products.

### DETAILED DESCRIPTION

The general inventive concepts will be understood more fully from the detailed description given below and from the accompanying drawings of the various aspects and implementations of the disclosure. This disclosure should not be taken to limit the general inventive concepts to the specific aspects or implementations, which are being provided for explanation and understanding only.

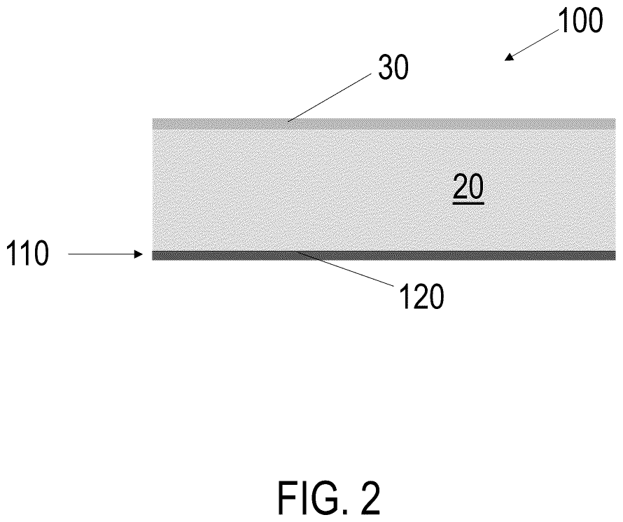

Referring now to the drawings, which are for purposes of illustrating several exemplary embodiments of the general inventive concepts, and not for limiting the same, FIG. 2 illustrates an exemplary embodiment of an improved insulation product, which may be an enhanced duct wrap insulation (also referred to as duct wrap).

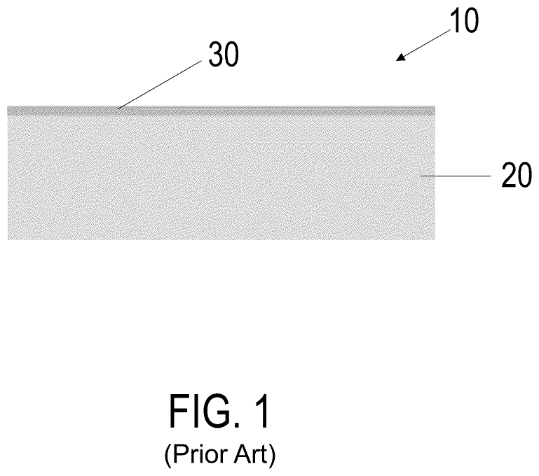

As shown in FIG. 2, the duct wrap of the invention, indicated generally at 100, is similar to the conventional duct wrap insulation 10 of FIG. 1 in that each duct wrap may include a first layer 20, formed of fibrous insulation materials (e.g., fiberglass) (the “fiberglass layer”), and a second layer 30 formed of facing materials (e.g., Foil Scrim Kraft facing materials) (also referred to as the “facer”). In some embodiments, as will be discussed herein, the duct wrap 100 may be dissimilar from the conventional duct wrap insulation 10 in that it may not include the facer 30.

It should be appreciated that the first layer 20 may be formed of other fibers, such as, for example, mineral fibers of rock, slag, or basalt, as well as organic fibers, such as, for example, polymer fibers (e.g., polypropylene, polyester, and polysulfide).

The fiberglass layer 20 may be formed by fiberizing molten material and depositing the fibers on a collecting conveyor. A binder material may also be used to bond the fibers together where they contact each other, forming a lattice or network. In some embodiments, the binder material may be a thermosetting resin that cures as the fiberglass layer 20 moves through an oven. One type of binder material commonly used with fiberglass insulation is a urea phenol-formaldehyde binder. Additionally, or alternatively, the fiberglass layer 20 may be binderless. “Binderless” means the absence of binder materials or the presence of only small amounts of such binder materials. In the case of a binderless insulating layer 20, the fibers may be mechanically entangled together.

The fiberglass layer 20 may have a density within the range of 0.75 pounds per cubic foot (pcf) to 1.5 pcf, although other densities may be used.

The facer 30 may be attached to a first surface (i.e., first major face) of the fiberglass layer 20 in any suitable manner, such as by an adhesive layer, drops, or strips. For example, a hot melt adhesive may be applied in liquid form to a surface of the fiberglass layer 20 (e.g., the first surface) and/or a side of the facer 30 that contacts the fiberglass layer 20. In some embodiments, the adhesive may be applied to the facer 30 while manufacturing, for example, the duct wrap 100. Additionally, or alternatively, the adhesive may be pre-applied to the facer 30 (i.e., prior to the manufacturing the duct wrap 100.)

The facer 30 may then be pressed into forceful contact with the first surface of the fiberglass layer 20, for example, by the action of one or more pressing rolls, for attaching the facer 30 to the first surface of the fiberglass layer 20. It should be appreciated that one or more of the pressing rolls may be heated for purposes of creating a bond between the facer 30 and the fiberglass layer 20.

The duct wrap 100 of FIG. 2 is dissimilar from the conventional duct wrap insulation 10 of FIG. 1 in that it includes at least a third layer 110 attached and/or selectively applied to a second surface (i.e., second major face) of the fiberglass layer 20. The second surface may be parallel to and opposite from the first surface, for example, on which the facer 30 may be attached.

The third layer 110 may be attached and/or bonded to the second surface of the fiberglass layer 20 in any suitable manner, such as by an adhesive layer or strip, heat lamination, and/or chemical bonding. In some embodiments, an adhesive in an amount of 10 g/m² to 100 g/m², including from 15 g/m² to 50 g/m², and also including from 25 g/m² to 35 g/m² may be used to attach and/or bond the third layer 110 to the second surface of the fiberglass layer 20.

In some embodiments, the third layer 110 may be bonded to the fiberglass layer 20 in a manner similar to how the facer 30 is attached to the fiberglass layer 20 (e.g., by applying a resin to the third layer 110). Additionally, or alternatively, the third layer 110 may be bonded to the fiberglass layer 20 using the binder material that bonds the fibers of the fiberglass layer 20 together. For example, before the binder mixture bonding the fibers is cured via an oven, the third layer 110 may be placed onto a surface of the fiberglass layer 20 and/or onto an uncured binder mixture of the fiberglass layer 20 and then heated via the oven. The heat from the oven may enable some of the binders bonding the fibers to connect or otherwise join the fiberglass layer 20 to the third layer 110.

In some embodiments, the binder may be a no-added formaldehyde binder or a formaldehyde-free binder. However, it should be appreciated that other binders (e.g., a phenolic binder) may be used for joining the fiberglass layer 20, and/or for adhering one or more additional layers to the fiberglass layer 20.

In some embodiments, the third layer 110 may be formed from one or more sheet materials (e.g., slip sheet materials). Types of slip sheet materials may include, for example, fiberglass veils, wax papers, skin coats of binders (e.g., an excess quantity of binder materials applied to the second surface and further processed to form the third layer 110), woven fabrics, and/or plastic films.

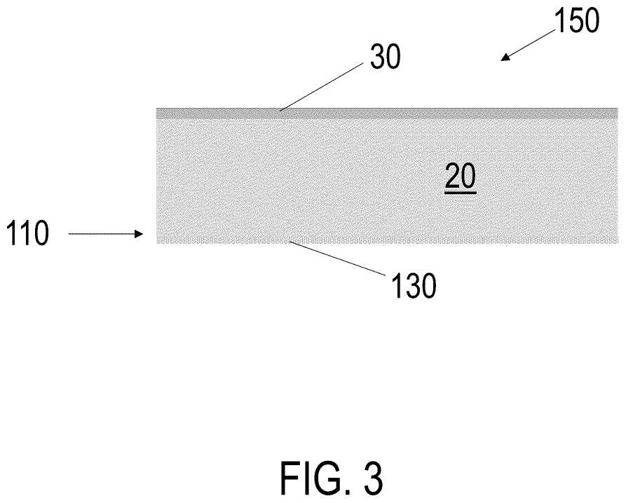

Similar to the duct wrap 100 of FIG. 2, and dissimilar to the conventional duct wrap insulation 10 of FIG. 1, the duct wrap 150 of FIG. 3 also includes a third layer 110. As shown in FIG. 3, the third layer 110 may be one or more lubricants 130. In some embodiments, the one or more lubricants 130 may be deposited or otherwise applied to (e.g., sprayed or rolled on) the second surface of the fiberglass layer 20, and processed to form the third layer 110.

In some embodiments, the lubricant 130 may be a silicone lubricating oil, although other oils may be used (e.g., a mineral oil, which may be derived from a crude oil, and/or a synthetic oil, which may be derived from a synthetic hydrocarbon). Additionally, or alternatively, the lubricant 130 may be a dry solid lubricant (e.g., a graphite, talc, and/or cornstarch).

In some embodiments, for example, where the third layer 110 is formed from a slip sheet material, the slip sheet material may have a basis weight between 0.1 g/m² and 75 g/m². Additionally, or alternatively, in embodiments where the third layer 110 is a fiberglass veil 120 (FIG. 2), the fiberglass veil 120 comprises chopped glass fibers combined with a binder (e.g., low solubility acrylic binder) and is nonwoven. The binder may be compatible with epoxy, vinyl ester, and polyester resins.

In some embodiments, the fiberglass veil 120 may have a basis weight between 0.56 g/m² and 32.0 g/m² (e.g., 25 g/m² or 27 g/m²). Additionally, or alternatively, the fiberglass veil 120 may have a thickness between 0.14 mm and 0.18 mm (e.g., 0.16 mm). It should be appreciated that the fiberglass veil 120 thickness should have little to no effect on the flexibility of the duct wrap product. The duct wrap product (inclusive of the third layer 110) must maintain its flexibility, for example, to allow the duct wrap 100 to be manipulated between narrow duct spaces.

In some embodiments, the fiberglass veil 120 may have a binder content between 9% and 20% (e.g., 10% to 15%), and a porosity between 350 l/m²/s and 5,750 l/m²/s (e.g., 5,250 l/m²/s). In some embodiments, a longitudinal tensile strength (Tensile MD) of the fiberglass veil 120 may be between 9 lbf/2 inches and 20 lbf/2 inches (e.g., 18 lbf/2 inches). Additionally, or alternatively, a transverse tensile strength (Tensile CMD) of the fiberglass veil 120 may be between 5 lbf/2 inches and 15 lbf/2 inches (e.g., 11 lbf/2 inches).

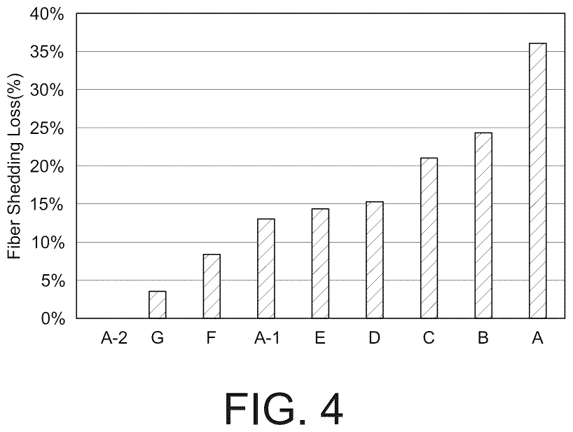

It should be appreciated that including the third layer 110, and in particular, the fiberglass veil 120 (e.g., as illustrated by the chart of FIG. 4), provides advantages over the conventional duct wrap insulation 10 because it reduces or completely eliminates peel-back and/or transfer of the fibers from the fiberglass layer 20.

FIG. 4 provides datapoints for nine (9) duct wrap insulation products (A, B, C, D, E, F, G, A-1, and A-2) that were tested to determine the percentage of fibers loss in each product due to fiber shedding (e.g., each product's “peel-back” loss percentage). Products A-1 and A-2 are variants of the “A” product. The A-1 variant includes a third layer 110 formed from one or more lubricants 130 (e.g., a silicone lubricating oil 130) sprayed or otherwise applied to an exposed surface of the A product. The A-2 variant includes a third layer 110 formed from a slip sheet material (e.g., a fiberglass veil 120) applied to the exposed surface of the A product. “Peel-back” loss refers to a loss of fibers and/or resin materials of an insulation product that may occur while maneuvering the product (e.g., during insulation) through tight spaces or around sharp edges.

As shown in FIG. 4, the A product had the highest peel-back loss percentage of all the tested products. FIG. 4 also shows that applying an additional layer (i.e., the third layer 110) to the A product significantly reduced the peel-back loss percentage in the A-1 product, and completely eliminated peel-back in the A-2 product. It should be appreciated that the additional layer (i.e., the third layer 110) provided the A product with a smoother surface to avoid fiber shedding (e.g., caused by peel-backs, insulation bunching, and the like), and that was less likely to catch on edges of ducts, for example, during installation.

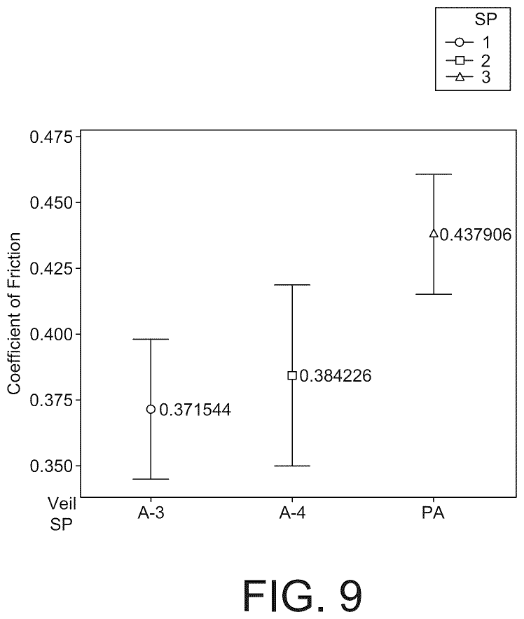

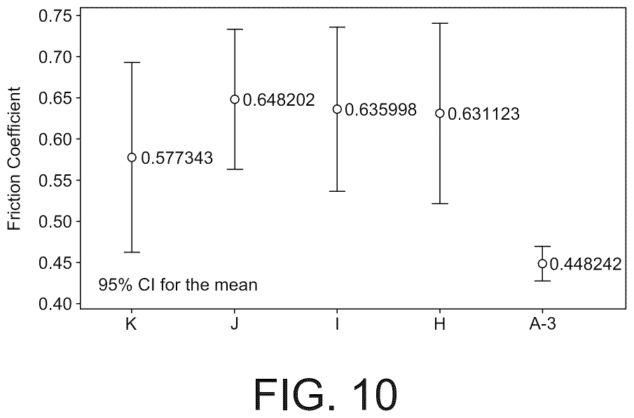

In some embodiments, the fiberglass veil 120 (e.g., as illustrated by the graphs of FIG. 9 and FIG. 10) provides an advantage by reducing the coefficient of friction (COF) between the duct wrap 100 and the duct work surfaces during the installation process, thereby reducing installer fatigue.

FIG. 9 provides datapoints for three (3) duct wrap insulation products/specimens (A-3, A-4, and PA) that were tested to determine each product's COF. Products A-3 and A-4 are also variants of the “A” product.

As shown in FIG. 9, the additional layer (i.e., the third layer 110) provided the A products (i.e., A-3 and A-4) with a reduced COF over the insulation product without the additional layer (i.e., the PA product).

FIG. 10 provides datapoints for five (5) duct wrap insulation products (A-3, H, I, J, and K) that were tested to determine each product's COF.

As shown in FIG. 10, the A product (i.e., A-3) had the lowest COF of all the tested products. It should be appreciated that the smoother surface provided by the third layer 110 of the A product improves the maneuverability of the A products over edges and through narrow duct spaces, which reduces installer fatigue.

Because installation of duct wrap products usually requires the duct wrap product to slide over metal ducts, the friction between the duct wrap product and the metal ducts is a significant component of the force needed to move the product into place. The friction component becomes more significant when installation requires squeezing the product through narrow gaps created by adjacent building components. Reducing the friction between the duct wrap product and the metal duct can reduce the physical strain on installers and decrease the likelihood of damage to the duct wrap product.

To measure COF, a duct wrap specimen (e.g., measuring about 3″×3″×10″) is slid through a narrow gap of about 1 inch, and the following formula:

$$COF = \frac{{F}_{friction}}{{F}_{⊥}}$$

is applied, where F_{friction} is the frictional force and F_{⊥} is the normal force required to compress the specimen to the desired gap width.

The following procedure was then followed to determine the duct wrap specimen's COF: (a) measuring the normal force, F_{⊥}, required to compress a specimen to a desired thickness using a load cell; and (b) measuring the force, F_{friction}, required to pull a specimen at a constant speed through a narrow gap having an upper and lower surface made of metal (e.g., stainless steel), and a thickness corresponding to the desired thickness in Step (a). In Step (b), the instrument's maximum crosshead speed of 20 inches per minute was used to better mimic the typical speeds at which a duct wrap product is slid across duct work. In Step (c), the COF was calculated according to the above COF Equation.

FIG. 10 shows the average (including a 95% confidence interval) for the COF measurements made on the five sample duct wrap products (A-3, H, I, J, and K). The A-3 product had statistically significantly lower COF than all other set points. The graph also shows that the A-3 product has a 20% lower COF than next closest product (i.e., the K product), and has about a 30% lower COF than the remaining products. It should be appreciated that the COF values shown in FIG. 10 resulted from a blend of two different metal interfaces: metal-veil and metal-foil, and that the A-3 product's COF with the metal-veil interface alone was at or about 0.37.

### Dust Generation and Fiber Transfer

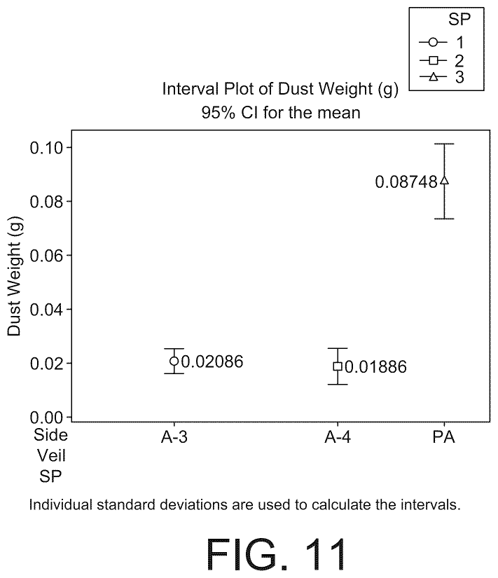

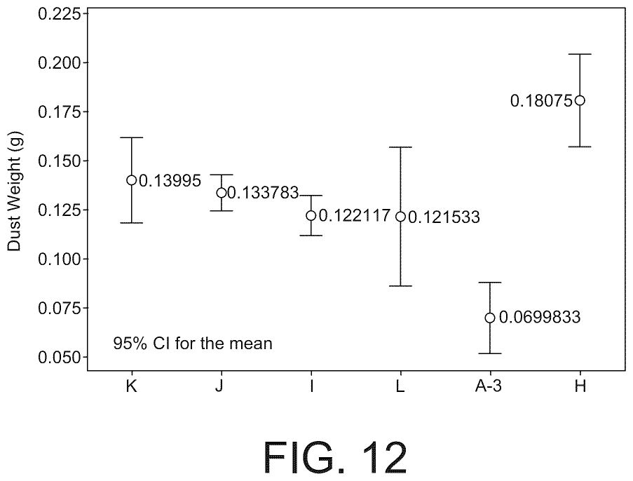

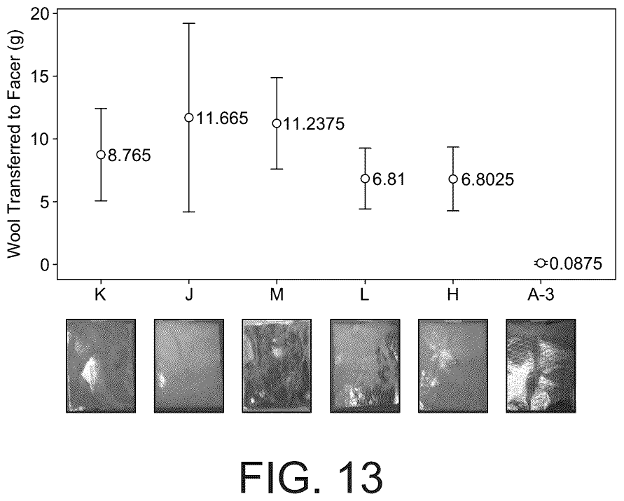

It should be appreciated that, in some embodiments, the fiberglass veil 120 (e.g., as illustrated by the graphs of FIG. 11, FIG. 12, and FIG. 13) also provides an advantage by suppressing generation of fiber dust, for example, released by the insulating layer 20, and by reducing or eliminating unsightly fiber patches, which may be caused by fiber transfer.

FIG. 11 provides datapoints for three (3) 24″×24″ duct wrap insulations products (A-3, A-4, and PA) that were tested to determine the dust generated (e.g., released) by each product.

As shown in FIG. 11, with the additional layer (i.e., the third layer 110) provided, the A products (i.e., A-3 and A-4) released less dust as compared to the insulation product without the additional layer (the “PA” product).

FIG. 12 provides datapoints for six (6) duct wrap insulations products (A-3, H, I, J, K, and L) that were tested to determine the dust generated (e.g., released) by each product.

As shown in FIG. 12, the A-3 product released the least amount of dust (in grams) of all the tested products. It should be appreciated that the smoother surface provided by the third layer 110 of the A-3 product reduces dust (e.g., air-born fiber irritants), all while gliding better around duct work with tight clearances and narrow gaps.

In some embodiments, the A-3 product releases dust particles equal to or less than 0.02 grams, during installation. In some embodiments, and to account for differences in the product sample area, the A-3 product releases dust particles equal to or less than 0.02 grams/4 ft²=0.005 g/ft², during installation.

It should be appreciated that dust may be emitted by most light density fiberglass products during installation and is a well-known complaint of duct wrap installers. To test the propensity of fiberglass to emit dust, a slotted tube vacuum method was employed. In this method, a vacuum is applied to the specimens (e.g., 15″×24″ specimens (FIG. 12)) as each specimen is pulled across a slotted tube for collecting dust onto filter paper media. The collected dust is then weighed on a scale. Here, the propensity of the A-3 product to emit dust was compared to competitive duct wraps (i.e., H, I, J, K, and L) using the slotted tube vacuum method on 3″ thick product samples.

FIG. 12 shows the set point averages, at 95% confidence intervals, for these tests. The A-3 product had statistically significantly lower levels of dust than all other set points. This suggests that the third layer 110 itself contributes to or is otherwise responsible for a 40% reduction in dust as compared to the best tested products (i.e., the I product and L product). The graph also shows that the A-3 product emits about 60% less dust than the remaining tested products.

FIG. 13 provides datapoints for six (6) duct wrap insulations products (A-3, H, J, K, L, and M) that were tested to determine the “fiber” (e.g., a wool fiber) transfer percentage.

As shown in FIG. 13, the A-3 product released the least amount of fibers of all the tested products. It should be appreciated that the smoother surface provided by the third layer 110 of the A-3 product eliminates fiber transfer and reduces dust, all while gliding better around duct work with tight clearances and narrow gaps. In some embodiments, the A-3 product loses less than 0.09 grams of fiber due to fiber transfer when unrolling the insulation product from a rolled state. In some embodiments, and to account for differences in the product sample area, the A-3 product loses less than 0.09 grams/1 ft²=0.09 g/ft² of fiber due to fiber transfer when unrolling the insulation product from a rolled state.

It should be appreciated that fiber transfer (also referred to as “sticking”) occurs when insulation from the duct wrap product (i.e., the insulating layer 20) transfers to the foil facer when the duct wrap product is being unrolled for installation. This can occur when the binder holding the fibers together is under-cured, or exposed to environmental conditions (like high temperatures and humidity) that would cause it to become tacky. Fiber transfer is a significant source of wasted material and labor for insulation contractors, as installers are forced to either discard severely affected products or use valuable installation time to carefully clean off mild to moderately affected products.

Unlike traditional duct wrap products, the A-3 product significantly, if not completely, blocks fiber transfer to the adjacent foil surface as it is unrolled for installation. To quantify the efficacy difference shown in FIG. 13, the following challenge test methodology (i.e., steps (a) to (l)) was developed. This methodology utilizes sugar water to create extremely sticky conditions in a rolled duct wrap product. The method steps include (a) cutting four pairs of 12″×12″ duct wrap product samples; (b) weighing one specimen out of each product pair; (c) making a solution of sugar water using equal parts sugar and water by volume; (d) spraying 2 grams of sugar water uniformly onto the insulation side of the un-weighed specimen using a spray bottle; (e) stacking the weighed specimen on top of the damp specimen so that its foil facing contacts the wet insulation surface (or the third layer 110 in case of the A-3 product); (f) compressing the stacked pair of specimens to a final thickness corresponding to the duct wrap product in compression packaging, until a final compression ratio of about 1:5 was achieved; (g) repeating Steps (d) through (f) for all the remaining product samples; (h) allowing all the product samples to dry for about 12 hours; (i) removing the product samples from the tool (e.g., a compression jig tool) used for compression; (j) peeling the first specimen away from the second specimen, starting at an unadhered corner. It should be appreciated that if there are no unadhered corners on any specimen, one may be created by gently peeling away the duct wrap product (or insulation) at a corner from the adjacent facing.

Step (k) includes reweighing the specimen from step (b); and Step (l) includes calculating the amount of fiber transfer by subtracting the weight in step (b) from the weight in step (k). FIG. 13 shows that the A-3 product completely prevented fiber transfer, while the other products lacking the third layer did not.

With continued reference to the drawings, in some embodiments, a combined thickness of the second layer 30 and the third layer 110 may be less than a thickness of the fiberglass layer 20 (See FIGS. 2-3). Additionally, or alternatively, and depending upon the type of slip sheet material used for forming the third layer 110, a thickness of the third layer 110 may be equal to or less than a thickness of the second layer 30.

Additionally, or alternatively, and for example, if a combination of slip sheet materials is used for forming the third layer 110, a thickness of the third layer 110 with combined slip sheet materials may be equal to or greater than a thickness of the second layer 30.

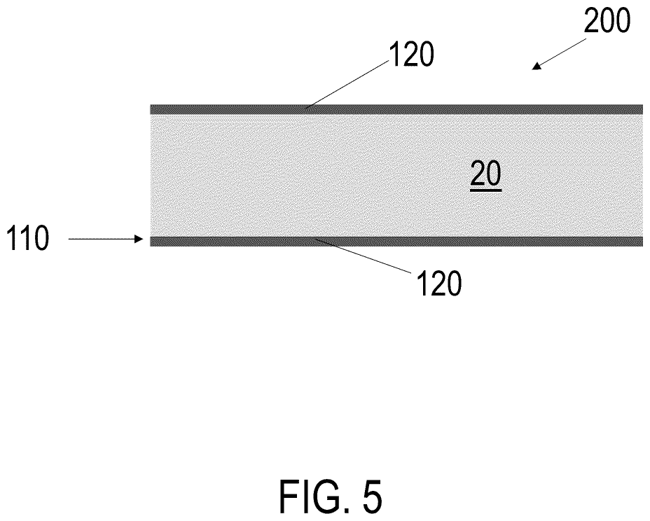

With continued reference to the drawings, and now with reference to FIGS. 5-7, additional exemplary embodiments of the invention are provided which are similar in many respects to the embodiments of the duct wrap 100 shown in FIG. 2 and the duct wrap 150 shown in FIG. 3, except for the omission of the facer 30.

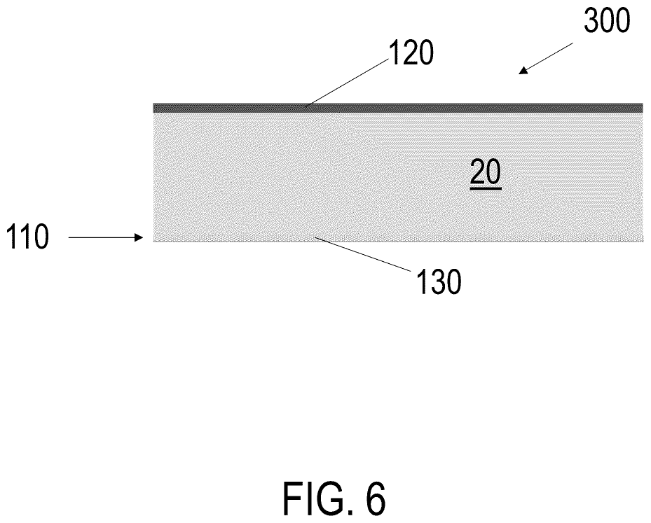

As shown in FIGS. 5-6, the facer 30 is replaced by one or more slip sheet materials used for forming the third layer 110. For example, the duct wrap 200 of FIG. 5 includes at least one fiberglass veil 120 disposed on opposite sides of the insulating layer 20. The exemplary embodiment of FIG. 6 shows a duct wrap 300 having at least one fiberglass veil 120 disposed on a first side of the insulating layer 20 and a silicone lubricating oil 130 disposed on a second side of the insulating layer 20 opposite the fiberglass veil 120.

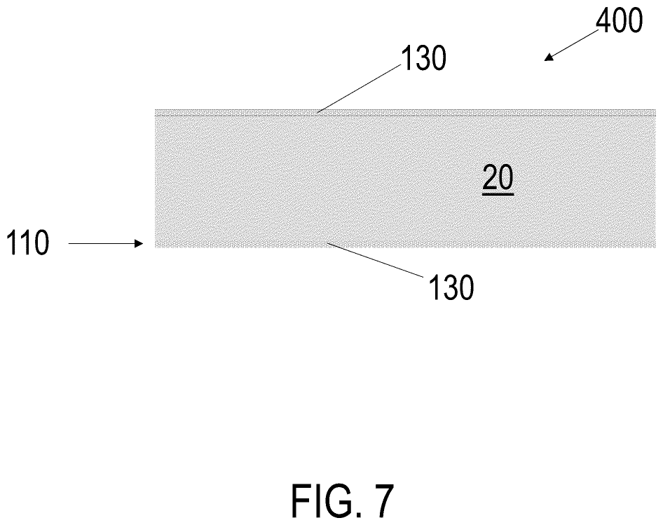

As shown in FIG. 7, the duct wrap 400 also does not include a facer 30. In this embodiment, the facer 30 is replaced by one or more lubricants used for forming the third layer 110 (e.g., the silicone lubricating oil 130).

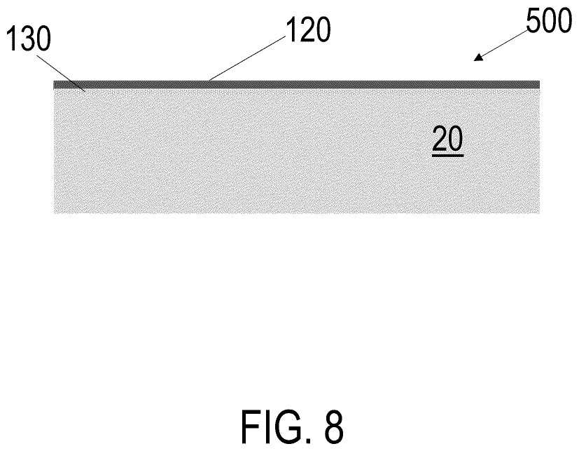

With continued reference to the drawings, FIG. 8 illustrates yet a further exemplary embodiment of the invention that is similar in many respects to the duct wrap 300 of FIG. 6, except that the duct wrap 500 includes only the fiberglass layer 20 covered by one or more slip sheet materials (e.g., the fiberglass veil 120) and one or more lubricants (e.g., a silicone lubricating oil 130), both on the same side of the fiberglass layer 20. In the embodiment of FIG. 8, the silicone lubricating oil 130 is disposed between the fiberglass layer 20 and the fiberglass veil 120. It should be appreciated that, in some embodiments, the fiberglass veil 120 may be disposed between the silicone lubricating oil 130 and the fiberglass layer 20. It should also be appreciated that the embodiments of the general inventive concepts (e.g., the duct wrap 500) may provide improved puncture and/or tear resistance not otherwise provided by the facer 30.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, any products, methods, and/or systems described herein are not limited to the specific details, the representative embodiments, and/or the illustrative examples shown and described. Accordingly, departures may be made from such details without departing from the spirit or scope of the general aspects of the present disclosure. The term “about” as used herein means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by 10%.

Additionally, the components and materials described hereinafter as making up the various embodiments are intended to be illustrative and not restrictive. It should be appreciated that many suitable components and materials that would perform the same or a similar function as the materials described herein are intended to be embraced within the scope of embodiments of the present disclosure.

What is claimed is:

1. A duct wrap comprising:
a fibrous insulation material;
a facing material secured to a first side of the insulation material; and
a protective layer secured to a second side of the insulation material,
wherein the first side of the insulation material and the second side of the insulation material are opposite one another;
wherein the protective layer is a non-woven veil comprising a plurality of glass fibers held together by a binder;
wherein the non-woven veil has a basis weight in the range of about 0.56 g/m² to about 32.0 g/m²;
wherein the non-woven veil has a thickness in the range of about 0.14 mm to about 0.18 mm; and
wherein the non-woven veil has a lower coefficient of friction than the second side of the insulation material.

2. The duct wrap of claim 1, wherein the non-woven veil has a thickness of about 0.16 mm.

3. The duct wrap of claim 1, wherein a combined thickness of the facing material and the non-woven veil is less than a thickness of the fibrous insulation material.

4. The duct wrap of claim 1, wherein the non-woven veil has a basis weight in the range of about 25.0 g/m² to about 27.0 g/m².

5. The duct wrap of claim 1, wherein the non-woven veil has a coefficient of friction in the range of about 0.35 to about 0.40.

6. The duct wrap of claim 1, wherein the non-woven veil has a coefficient of friction in the range of about 0.37 to about 0.38.

7. The duct wrap of claim 1, wherein the non-woven veil has a longitudinal tensile strength in the machine direction in the range of about 9 lbf/2 inches to about 20 lbf/2 inches.

8. The duct wrap of claim 1, wherein the non-woven veil has a transverse tensile strength in the cross machine direction in the range of about 5 lbf/2 inches to about 15 lbf/2 inches.

9. The duct wrap of claim 1, wherein the non-woven veil has a porosity in the range of about 350 l/m²/s to about 5,750 l/m²/s.

10. The duct wrap of claim 1, wherein the non-woven veil has a binder content in the range of about 9% to about 20%.

11. The duct wrap of claim 1, wherein the fibrous insulation material comprises a plurality of glass fibers.

12. The duct wrap of claim 1, wherein the facing material is a foil scrim kraft material.

13. The duct wrap of claim 1, wherein the duct wrap is operable to release dust particles equal to or less than 0.02 grams during installation.

14. The duct wrap of claim 1, wherein the duct wrap is operable to be placed in a rolled state.

15. The duct wrap of claim 14, wherein the duct wrap loses less than 0.09 grams of fiber due to fiber transfer when unrolling the insulation product from the rolled state.

16. A duct wrap comprising:
a fibrous insulation material;
a first protective layer secured to a first side of the insulation material; and
a second protective layer secured to a second side of the insulation material,
wherein the first side of the insulation material and the second side of the insulation material are opposite one another;
wherein the first protective layer is a first non-woven veil comprising a plurality of glass fibers held together by a binder;
wherein the first non-woven veil has a basis weight in the range of about 0.56 g/m² to about 32.0 g/m²;
wherein the first non-woven veil has a thickness in the range of about 0.14 mm to about 0.18 mm;
wherein the first non-woven veil has a lower coefficient of friction than the first side of the insulation material;
wherein the second protective layer is a second non-woven veil comprising a plurality of glass fibers held together by a binder;
wherein the second non-woven veil has a basis weight in the range of about 0.56 g/m² to about 32.0 g/m²;
wherein the second non-woven veil has a thickness in the range of about 0.14 mm to about 0.18 mm; and
wherein the second non-woven veil has a lower coefficient of friction than the second side of the insulation material.

17. A duct wrap comprising:
a fibrous insulation material;
a first protective layer secured to a first side of the insulation material; and
a second protective layer applied to a second side of the insulation material,
wherein the first side of the insulation material and the second side of the insulation material are opposite one another;
wherein the first protective layer is a non-woven veil comprising a plurality of glass fibers held together by a binder;
wherein the non-woven veil has a basis weight in the range of about 0.56 g/m² to about 32.0 g/m²;
wherein the non-woven veil has a thickness in the range of about 0.14 mm to about 0.18 mm;
wherein the non-woven veil has a lower coefficient of friction than the first side of the insulation material; and
wherein the second protective layer is a lubricant.

18. The duct wrap of claim 17, wherein the lubricant is an oil.

19. The duct wrap of claim 17, wherein the lubricant is a silicone oil.
